(19) United States
(12) Patent Application Publication
(10) Pub. No.: US 2014/0150625 A1
(43) Pub. Date: Jun. 5, 2014

(54) ACOUSTIC STRING INSTRUMENT

(71) Applicant: Michael Miltimore, Kamloops (CA)

(72) Inventor: Michael Miltimore, Kamloops (CA)

(21) Appl. No.: 14/118,137

(22) PCT Filed: May 15, 2012
(86) PCT No.: PCT/IB2012/000949

§ 371 Date: Feb. 11, 2014

Related U.S. Application Data
(63) Continuation-in-part of application No. 13/107,940, filed on May 15, 2011, now abandoned.

(51) Int. Cl. G10D 3/02; G10D 1/08; G10D 1/00

(52) U.S. Cl. CPC G10D 3/02; G10D 1/005; G10D 1/08
USPC 84/267; 29/896.22; 84/294; 84/293

(57) ABSTRACT

A sliding saddle system and a method of constructing a chordophone instrument comprising an underblock in slidable engagement with the bridge plate. A connector is located between the saddle and the underblock allowing the underblock to slide into position on the bridge plate until the connector is tightened, thereby locating the saddle on the sound board.

### FIELD

The present technology is directed to a string instrument in which the stresses and strains on the soundboard are reduced through the implementation of a sliding saddle system, an interior strut and an offset headstock. More specifically, the present technology is directed to a guitar having sliding saddles, an interior strut and an offset headstock.

### BACKGROUND

Acoustic string instruments are subjected to high stresses and strains caused by the strings. As the instrument is tuned, the strings are tightened, leading to force developing between the neck and the soundbox. The direct recipient of the force is the bridge. The force is then indirectly exerted on the soundboard. This may lead to damage to both the bridge and the soundboard. In extreme cases, the neck can also be affected by damaging the joint between the neck and the soundbox of the instrument.

The inner surfaces of the soundboard and back of guitars are provided with bracing to counteract the force. A complex pattern of bracing is used on the inner surface of the back. During construction of the instrument, a luthier spends a significant amount of time shaping the bracing in order to tune the instrument. In order to reduce the work, Griffiths (U.S. Pat. No. 6,333,454) provides a bracing system that combines kerfing, binding and bracing. One unit is for use with the soundboard and a second unit is for use with the back.

In U.S. Pat. No. 7,462,767, a bracing system is used to counter balance the force by using an additional string or cable, preferably made of Kevlar, carbon fiber or a similar non-elastic material that is attached to the bridge and the neck of the guitar within the soundbox. A bracket is located inside the soundbox of the instrument and attached to the bottom of the bridge of the instrument. It is connected to an adjustable brace by a non-elastic string. The adjustable brace may adjust the tension placed upon the string to control the amount of counter-balancing tension. This system does not alleviate the force, but rather, simply counter balances the force.

Another cause of stress to the instrument arises because the strings are not aligned between the headstock and the bridge such that they are normal to the bridge. The strings therefore exert a twisting force on the bridge and soundbox.

Despite the fact that many instruments are damaged by the two forces, those of the force on the bridge and soundboard and the force on the neck and the soundbox, the string instrument industry is reluctant to make change to reduce the forces exerted, preferring to retain the “look” of the instrument in preference to the health of the instrument.

### SUMMARY

The present technology provides combinations for reducing the forces exerted by the strings on instruments in the chordophone family.

On aspect is a sliding saddle system reduces the tension on the soundboard thereby allowing the top to resonate freely with minimal bracing for strength, as much of the tension is relieved. The sliding saddle system also allows for intonating each string easily.

Another aspect is a strut that runs from the neck distal end to the distal end of the soundbox, more specifically, to the end block located at the distal end of the soundbox. The strut has course and fine adjustors to allow adjustment towards and away from the soundboard. Adjustment of the strut position adjusts the neck angle and the string height.

Yet another aspect of the combination is an offset headstock. The offset headstock has two tuning keys and the side opposite to the offset has four tuning keys. It reduces the stresses and strains on the nuts of the guitar.

The technology further provides a kerfing unit that is integral with the soundboard and the back. This allows for easy and quick assembly of the string instrument and, as it the 70% smaller than conventional binding and kerfing, it provides more resonant area. It also reduces the number of steps in construction.

Another aspect of the technology is a peripheral tuning groove.

A method of constructing a chordophone instrument with the above features is also provided.

### FIGURES

FIG. 1 is a perspective view of the guitar of the present technology.

FIG. 2 is a longitudinal section view of the guitar of FIG. 1.

FIG. 3 is an end view of the guitar of the FIG. 1.

FIG. 4 is a cross sectional view of the kerfing unit of the present technology prior to removal of the outer contour.

FIG. 5 is a plan view of the sliding saddle system of the present technology.

FIG. 6 is an exploded view of the neck region of the technology of FIG. 1.

FIG. 6A is a plan view of the soundboard of the technology of FIG. 1.

FIG. 7 is a longitudinal section view of the technology of FIG. 1.

### DETAILED DESCRIPTION

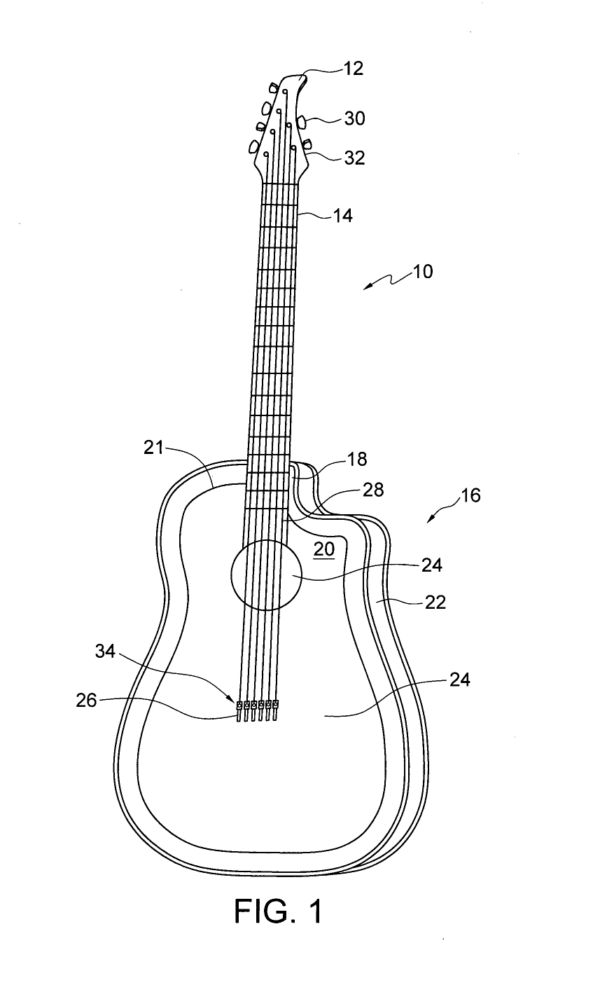

A guitar, generally referred to as 10 is shown in FIG. 1. The guitar has a headstock 12 and a neck 14 extending therefrom. The neck 14 is connected to a soundbox, generally referred to as 16 at a proximal end 18 of the soundbox 16. The soundbox 16 has a soundboard 20 forming the top of the soundbox 16 and sides 22. The soundboard 20 has a narrow, 2 mm deep groove around the periphery referred to as a “peripheral tone groove”21. The tone groove 21 allows the soundboard 20 to be more flexible. A sound hole 24 is located centrally in the soundboard 20. Slots 26, corresponding in number to the number of strings 28 are also located in the soundboard 20. The headstock 12 is provided with tuning keys 30. In the prior art, the headstock is symmetrical and there are an equal number of tuning keys 30 on either side of the headstock 12. In contrast the headstock 12 of the present technology has an offset 32. There are two tuning keys 30 located on the same side as the offset 32 and four tuning keys 30 located on the side opposite to the offset 32. This allows the strings 28 to extend in a parallel manner between the headstock 12 and a sliding saddle system, generally referred to as 34 and to be normal to the sliding saddle system 34. A stationary voice coil with moving magnet 35 is provided to move the soundbox 16.

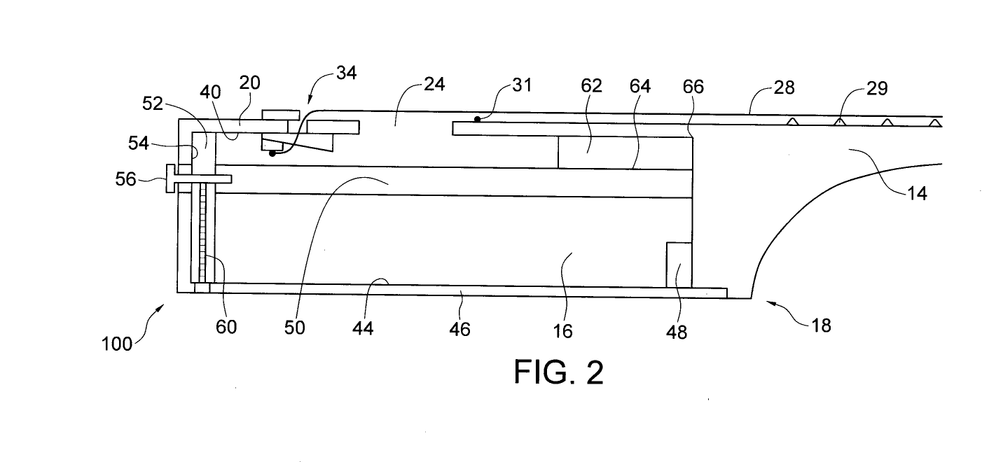

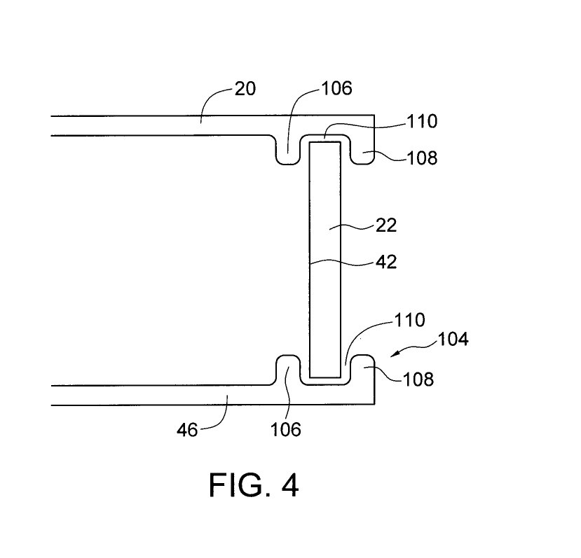

As shown in FIG. 2, it can be seen that the soundbox 16 is defined by the inner surface 40 of the soundboard 20, the inner surface 42 of the sides 22 (see FIG. 4) and the inner surface 44 of the back 46. The neck is attached to the neckblock 48 and has an integral fretboard with frets 29. The strings 28 pass over the frets 29 and nuts 31 do not terminate at pins that are engaged with the bridge as occurs in the guitar prior art or the tail piece as occurs in the violin prior art, but rather terminate at the sliding saddle system, generally referred to as 34.

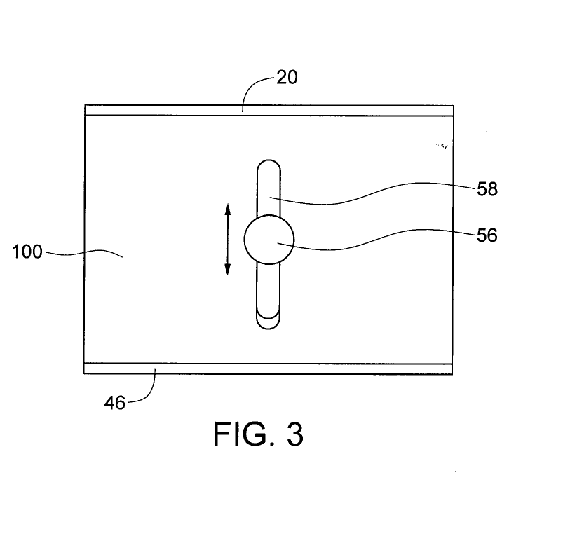

FIG. 2 also shows a strut 50 that abuts an end block 52 located on the distal inner surface 54, and is adjustably affixed by a bolt 56 or by the strap peg. As shown in FIG. 3, the bolt 56 extends through a substantially vertical slot 58 (vertical in this context means that it extends a distance between the soundboard 20 and the back 46) in both the end block 52 and the side 22 at a distal end 100. The arrow shows how the placement of the bolt 56 can be adjusted. A fine adjustment screw 60 in the end block 52 is vertically disposed and abuts the bolt 56. The adjustments alter the effective length of the strut 50, in other words, the distance between the distal end, generally referred to as 100 and the proximal end, generally referred to 18, of the soundbox 16 (as shown in FIG. 2). More significantly, the adjustment allows for adjustment of the height of the strings, by adjusting the neck angle. This is of further benefit because it doesn't change the break angle of the strings. A plate 62 is located on the strut 50 on an upper surface 64 and abuts the neck 14 at the neck distal end 66.

As shown in FIG. 4, during construction, a kerfing unit, generally referred to as 104 is integral with the back 46 and the soundboard 20. The kerfing unit 104 is comprised of an inner contour 106 and an outer contour 108 with a valley 110 therebetween. The unit 104 runs the perimeter of the back 46 and the soundboard 20. The sides 22 are seated in the valley 110 and glued in place. The outer contour 108 is then removed by routing, or laser cutter, or the like, leaving an integral kerfing unit 104 to provide structural support for the soundbox 16. The kerfing unit 104 is significantly smaller than conventional kerfing and is both easier to construct and use during construction of the guitar 10. Further, binding is not required.

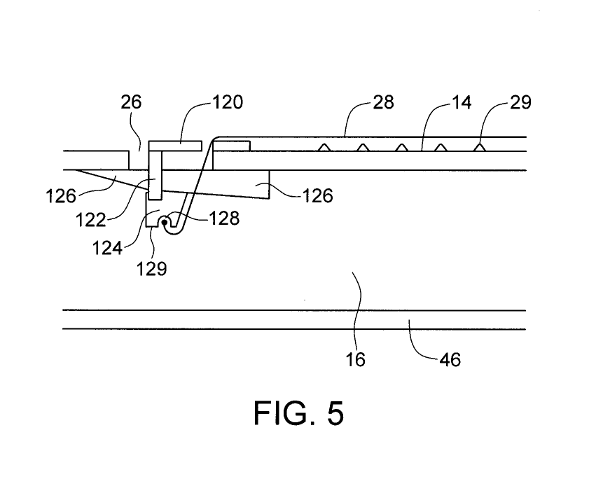

The sliding saddle system 34 (shown in FIG. 1) consists of a series of saddles 120, a series of connectors 122, a series of underblocks 124 and a bridge plate 126. The number of saddles 120, connectors 122 and underblocks 124 correspond to the number of strings 28 and the number of slots 26. As shown in FIG. 5, each saddle 120 is in engagement with an underblock 124 by means of a connector 122. The bridge plate 126 is located in the soundbox 16 and is tapered distally, such that it is thickest towards the neck 14 of the guitar 10, i.e. it tapers distally normal to the longitudinal axis of the saddle. It is glued to the inner surface 40 of the soundboard 20 and is slotted. The underblock 124 abuts the bridge plate 126. The connector 122 is adjustable and when loosened allows the saddle 120, connector 122 and underblock 124 to move proximally and distally in the slot 26. The combination of the saddle 120, connector 122 and underblock 124 therefore both allows for adjusting intonation of each string 28 and relieves tensions that would normally be present on the bridge and soundboard of a conventional guitar. This allows the soundboard 20 to function solely as a resonant membrane rather than a structural support and resonant membrane.

Each saddle 120 has a wedge-shaped opening at a proximal end to engage the string 28. The string 28 passes through the wedge-shape opening and passes through the slot 26 in both the soundboard 20 and the bridge plate 126. The string 28 terminates in a recess 128 on an underside 129 of the underblock 124, as shown in FIG. 5.

In another embodiment, the connector 122 is integral with the saddle 120 and the unit is constructed of a material, such as a plastic polymer.

In all embodiments, in order to reduce stresses on the soundboard 20, it is preferable that the circular movement of the strings 28 when strummed is accommodated by resultant movement of the saddles 120 in at least two planes (up and down and side to side) and preferably in a circle, therefore in all embodiments the connector 122, whether integral or not is selected to provide such movement (referred to as “substantially rotatable”). Additionally, the design reduces torsional stress on the soundboard. This differs from a conventional guitar as the pins of a conventional guitar only accommodate up and down movement of the strings 28, thereby resulting in torsional stress on the soundboard.

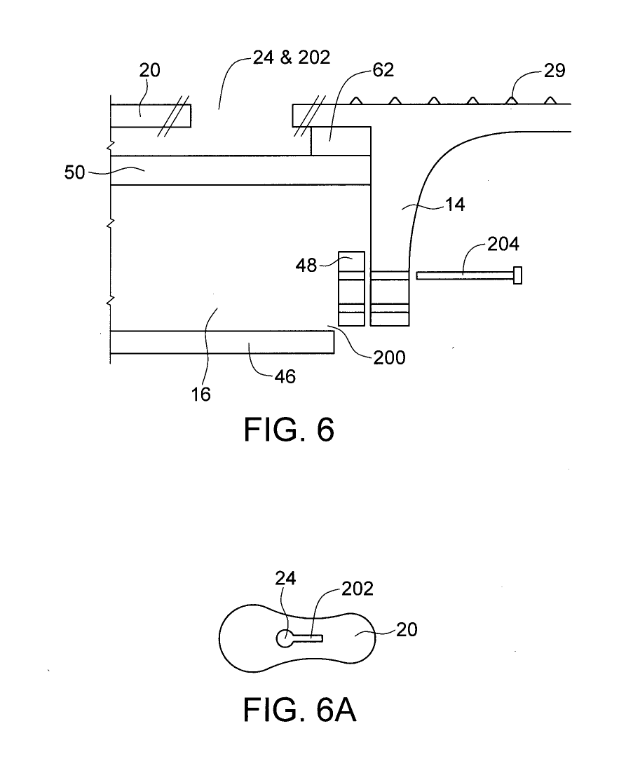

As shown in FIG. 6, it can be seen that a soundbox aperture 200 is provided in the soundbox 16 for receiving the neck 14 and strut 50. These are assembled and then introduced as a unit. The neck 14 and integral fretboard with frets 29 is accepted into the soundhole slot 202, which is an extension of the soundhole 24. This can be seen in inset 6A. A bolt 204 retains the neck 14 to the neck block 48.

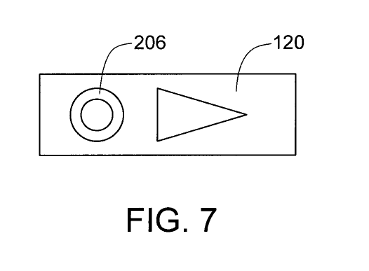

As shown in FIG. 7, the saddles 120 are can be each provided with transducers 206 or musical instrument digital interface (MIDI). This allows for individual processing of each string.

The guitar of the present technology can be assembled very quickly as follows:

### 1. Construction of the Body of the Guitar:

The soundboard and the back are machined to have the integral kerfing unit 104. This is used to attach the sides 22 to the soundboard 20 and back 46 of the guitar 10. Once glued, the outer contour 108 is removed by routing or laser cutting or the like.

### 2. Introduction of the Strut:

The neck 14, neckblock 48 and strut 50 are slid into the soundbox 16 of the guitar 10 as a unit, through the soundbox aperture 200. The strut 50 abuts the end block 52 located on the distal inner surface 42, and is adjustably affixed by a bolt 56 or by the strap peg. The bolt 56 extends through a substantially vertical slot 58 (vertical in this context means that it extends a distance between the soundboard 20 and the back 30) in both the end block 52 and the side 22 at a distal end 100 of the guitar 10. The strut is adjusted by adjusting both the bolt 56 and the adjustment screw 62.

### 3. Introduction of the Sliding Saddle System:

The sliding saddle system 34 is then assembled by placing the series of saddles 120 on the soundboard 20, slotting the connectors 122 into the slots 26, attaching them to the underblocks 124, and tightening the connectors 122 such that the saddles 120 are located on the soundboard 20 and the underblocks 124 are located on the bridge plate 126.

### 4. Adjustment of the Strut:

Adjustments are made by altering the position of the bolt 56 by sliding it up or down in the vertical slot 58. Screw 62 is used to make fin adjustments. Once appropriately located, the bolt 56 is tightened. These adjustments alter the angle of the neck.

### 5. Stringing the Instrument:

The instrument is strung by threading each string 28 through the wedge-shaped opening on the saddle 120, through the soundboard 20 via the slots 26 and terminating the string 28 on the underside of the corresponding underblock 124, by wedging the string 26 into the recess 128 in the underside 129 of the underblock. The strings 28 are wound onto the tuning keys 30, noting that the alignment of the strings 28 is kept normal to the sliding saddle system 34 by the offset 32. In the preferred embodiment, this comprises attaching two strings to the tuning keys in the vicinity of the offset and four strings to the tuning keys opposite the offset.

### 6. Intonating the Guitar:

The sliding saddle system 34 is slid proximally or distally in the slots 26 and along the bridge plate 126. Once located, the connectors 122 are tightened such that the sliding saddle system 34 is firmly located in place on the soundboard 20 and the bridge plate 126.

### 7. Tuning the Strings:

The sliding saddle system 34 and strut 50 allow the soundbox 16 to be vibration free or essentially vibration free, because string contact and tension can be eliminated from the sound box. A digital system such as, but not limited to Antares Auto-Tune® can be used to adjust and correct the pitch of each string. Such adjustment has not been useful for acoustic guitars, because of the soundbox vibration.

If the guitar 10 is adjusted to provide an essentially vibration free soundbox 16, the stationary voice coil with moving magnet 35 can be used to control movement of the soundboard 20.

The foregoing is a description of an embodiment of the technology. As would be known to one skilled in the art, variations that do not alter the scope of the technology are contemplated. For example, the instrument may have more or less than six strings and need not be a guitar, but any instrument in the chordophone family, for example but not limited to a violin, a ukulele, lute or mandolin. Regardless of the plurality of strings, the offset will allow for an uneven distribution of the tuning keys between the sides of the headstock, thereby allowing for the strings to be normal to the sliding saddle system. Further, more than one set of strings can be used, for example, the instrument could have a six string and twelve strings embodiment, and more than one strut could be employed. The neck and strut could be a unit body construction, the strut could be a solid member, or could be a truss. The sliding saddle system could be a variety of shapes. The guitar may be provided with only the strut and related components, or may be provided with both the strut and sliding saddle system. The peripheral tone groove is generally ½the thickness of the soundboard, but may be ¼ the thickness, or ⅜ the thickness, or as much as ⅝ the thickness and is located in the vicinity of the periphery of the soundboard, for example, but not limited to, between 1 and 3 cm from the periphery, more preferably 1.5 to 2.5 cm from the periphery and most preferably 2 cm from the periphery.

1. A sliding saddle system for a chordophone instrument, the instrument having a neck, a soundboard and a soundbox, the sliding saddle system having at least one combination comprising:
i) a bridge plate, the bridge plate for connecting to an inner surface of the soundboard;
i) a saddle for locating on the soundboard, the saddle comprising an opening for accepting a string and directing it through a slot in the soundboard;
iii) an underblock for retaining the string, the underblock in slidable engagement with the bridge plate; and
iv) an adjustable connector, for connecting the saddle to the underblock, such that in use, the underblock is slid into position on the bridge plate, and the connector is tightened, thereby locating the saddle on the soundboard.

2. The sliding saddle system of claim 1 wherein there are six combinations.

3. The sliding saddle system of claim 2 further comprising a transducer on the saddle of each combination.

4. The sliding saddle system of claim 2, wherein the bridge plate is a single unit and is wedge-shaped with a taper normal to a longitudinal axis of the saddle.

5. A chordophone instrument having a headstock, a neck, a bridge, at least one string and a soundbox, the soundbox comprising sides, a back and a soundboard, the soundboard comprising a soundhole, wherein the improvement comprises a strut, the strut housed in the soundbox and spanning between a distal end of the neck and an end block affixed to the distal end of the soundbox, the strut adjustably connected to the end block to allow adjustment of the strut towards and away from the soundboard, thereby adjusting neck angle and string height.

6. The instrument of claim 5, wherein the instrument is a guitar.

7. The instrument of claim 6 further comprising an at least one slot distal to the soundhole and a sliding saddle system, and the sliding saddle system having at least one combination comprising:
i) a bridge plate, the bridge plate connected to an inner surface of the soundboard;
i) a saddle slidably located on the soundboard in the vicinity of the slot, the saddle comprising an opening for accepting the string and directing it through the slot in the soundboard;
iii) an underblock retaining the string, the underblock in slidable engagement with the bridge plate; and
iv) an adjustable connector connecting the saddle to the underblock.

8. The instrument of claim 7, further characterized in that the headstock has an offset.

9. The instrument of claim 8, wherein the headstock is configured to accept six strings, such that two strings terminate in the vicinity of the offset and four strings terminate opposite the offset.

10. The instrument of claim 7, further characterized in that the soundboard and back have integral kerfing units.

11. The instrument of claim 7, further characterized in that the neck has an integral fretboard.

12. The instrument of claim 7, further comprising transducers located on each saddle.

13. The instrument of claim 11, further comprising at least one voice coil and moveable magnet.

14. The instrument of claim 11, further comprising a peripheral toning groove in the soundboard.

15. A headstock for a neck of a chordophone instrument, the headstock comprising an offset side and an opposite side and being configured to accept fewer tuning keys on the offset side, such that in use, the strings are parallel to the neck.

16. The headstock of claim 15, wherein the headstock is configured to accept two tuning keys on the offset side and four tuning keys on the opposite side.

17. A method of constructing a chordophone instrument, the chordophone instrument comprising a headstock, a neck, a bridge and a soundbox, the soundbox comprising sides, a back and a soundboard, the soundboard comprising a soundhole and at least one slot distal to the soundhole,
the method comprising:
attaching a bridge plate to an underside of the soundboard in the vicinity of the slot;
attaching the back and soundboard to the sides to provide the soundbox having a soundbox aperture;
connecting a strut to the neck at a neck distal end;
introducing the strut and neck into the soundbox through the soundbox aperture and affixing it therein;
locating at least one saddle and underblock about the slot, the underblock located under the bridge plate; and
affixing the saddle to the underblock.

18. The method of claim 17 further comprising adjusting the neck angle and string height.

19. The method of claim 18, further comprising adjusting the placement of the saddle and underblock.

20. The method of claim 19, further comprising preparing the soundboard and back with integral kerfing units.
